(19) United States
(12) Patent Application Publication
(10) Pub. No.: US 2013/0200636 A1
(43) Pub. Date: Aug. 8, 2013

(54) HANDLE-ACTUATED LOCKS

(71) Applicant: Amesbury Group, Inc., Amesbury, MA (US)

(72) Inventors: Bruce Hagemeyer, Pella, IA (US); Dan Raap, Hartford, SD (US); Gary E. Tagtow, Sioux Falls, SD (US)

(73) Assignee: Amesbury Group, Inc., Amesbury, MA (US)

(21) Appl. No.: 13/753,035

(22) Filed: Jan. 29, 2013

Related U.S. Application Data
(60) Provisional application No. 61/595,971, filed on Feb. 7, 2012.

(51) Int. Cl. E05B 1/00; E05C 3/14

(52) U.S. Cl. CPC E05B 1/00; E05C 3/14
USPC 292/202; 292/336.3

(57) ABSTRACT

A lock assembly includes an escutcheon and a handle pivotably connected to the escutcheon at an interface. The handle includes a projection for engaging a clutch of a slide. A cam is pivotably engaged with the slide and includes a tailpiece adapted for engagement with a locking mechanism. Lifting or lowering the handle actuates the lock.

### CROSS-REFERENCE TO RELATED APPLICATIONS

This application claims priority to and the benefit of U.S. Provisional Patent Application Ser. No. 61/595,971, filed Feb. 7, 2012, entitled “Handle-actuated Locks,” the disclosure of which is hereby incorporated by reference herein in its entirety.

### INTRODUCTION

Many locks, for both sliding and hinged doors, utilize both a handle for moving the door and a thumbturn or other actuation device for locking and/or latching the door. In sliding doors, for example, a fixed handle and a pivotable thumbturn are used to move and lock the door, respectively. In hinged doors, a pivotable handle or door knob is used to latch and unlatch the door, while a separate thumbturn is used to lock the lock. In many devices, the position of the thumbturn and, accordingly, the latch or lock element, may be difficult to ascertain. In such cases, an operator may believe the door to be locked when it is actually not so. Additionally, thumbturns are often small (so as to not detract from door aesthetics) and may be difficult for an operator to manipulate. This may be especially true in the case of a disabled operator who may have difficulty grasping, pinching, or rotating the thumbturn. To address this, the Americans with Disabilities Act (ADA) requires that an ADA-compliant door must be able to be opened and closed with less than five pounds of force applied to the door knob and locking element actuator (that is, the thumbturn).

### SUMMARY

In one aspect, the technology relates to a lock assembly including: an escutcheon; a handle pivotably connected to the escutcheon at an interface, the handle including a projection; a slide including a clutch, wherein the projection engages the clutch; a cam pivotably engaged with the slide, the cam including a tailpiece adapted for engagement with a locking mechanism. In an embodiment, the interface includes an interface axis and the tailpiece includes a tailpiece axis, the cam pivots about the tailpiece axis, and the interface axis and the tailpiece axis are skew. In another embodiment, the escutcheon defines an escutcheon plane, and the interface axis is at least one of parallel to the escutcheon plane or located within the escutcheon plane. In yet another embodiment, the tailpiece axis is orthogonal to the escutcheon plane. In still another embodiment, the handle is pivotable between a first handle position and a second handle position, the slider is movable between a first slider position and a second slider position, the cam is pivotable between a first cam position and a second cam position, and when the handle is in the first handle position, the slider is in the first slider position, and the cam is in the first cam position.

In an embodiment of the above aspect, the handle is pivotable to a third handle position, the slider is movable to a third slider position, the cam is pivotable to a third cam handle position, and when the handle is in the third handle position, the slider is in the third slider position, and the cam is in the third cam position. In another embodiment, the lock assembly includes a spring for biasing the slider from the third slider position to the first slider position. In yet another embodiment, the slider includes a cam-mating projection and the cam defines a slot for receiving the cam-mating projection. In still another embodiment, when in a first handle position, a front surface of the handle is flush with the escutcheon. In another embodiment, the lock assembly includes the locking mechanism. In another aspect, the technology relates to a door lock including the lock assembly described above.

### BRIEF DESCRIPTION OF THE DRAWINGS

There are shown in the drawings, embodiments which are presently preferred, it being understood, however, that the technology is not limited to the precise arrangements and instrumentalities shown.

FIGS. 1A and 1B are perspective views of a lock assembly in a locked position and an unlocked position, respectively.

FIGS. 2A-2D are perspective views of components of the lock assembly of FIGS. 1A and 1B.

FIGS. 3A and 3B are perspective views of the lock assembly of FIGS. 1A and 1B, partially assembled, in the locked position.

FIGS. 3C and 3D are perspective views of the lock assembly of FIGS. 1A and 1B, partially assembled, in the unlocked position.

FIGS. 4A and 4B are perspective views of the lock assembly of FIGS. 1A and 1B, partially assembled, in the locked position and the unlocked position, respectively.

FIG. 5A-5C are perspective views of a lock assembly in latched, unlatched, and locked positions, respectively.

FIG. 6 is a perspective view of components of the lock assembly of FIGS. 5A-5C.

FIGS. 7A-7B are perspective views of components of the lock assembly of FIGS. 5A-5C.

FIG. 8A-8C are perspective views of the lock assembly of FIGS. 5A-5C, partially assembled, in latched, unlatched, and locked positions, respectively.

### DETAILED DESCRIPTION

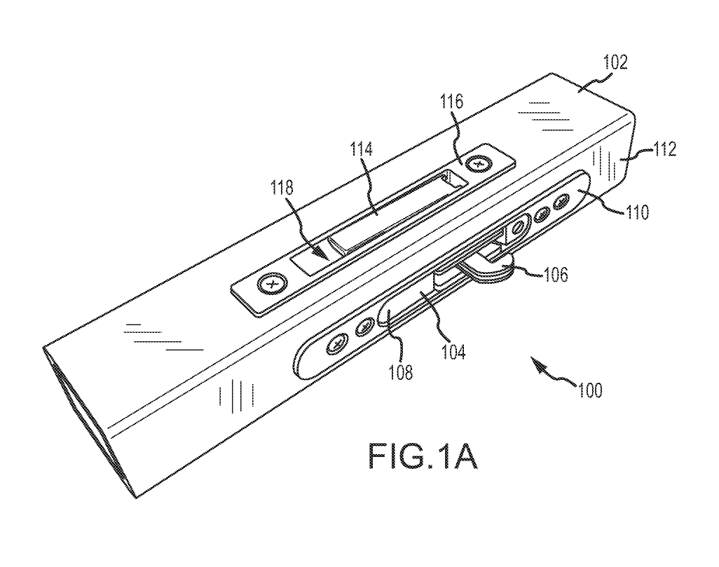

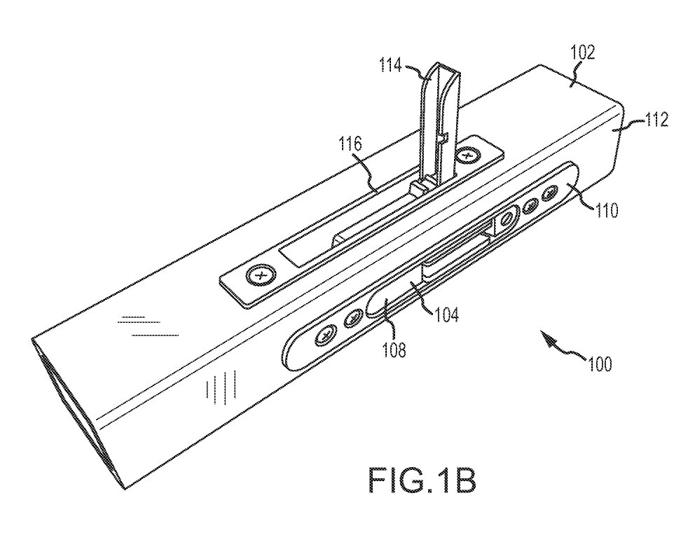

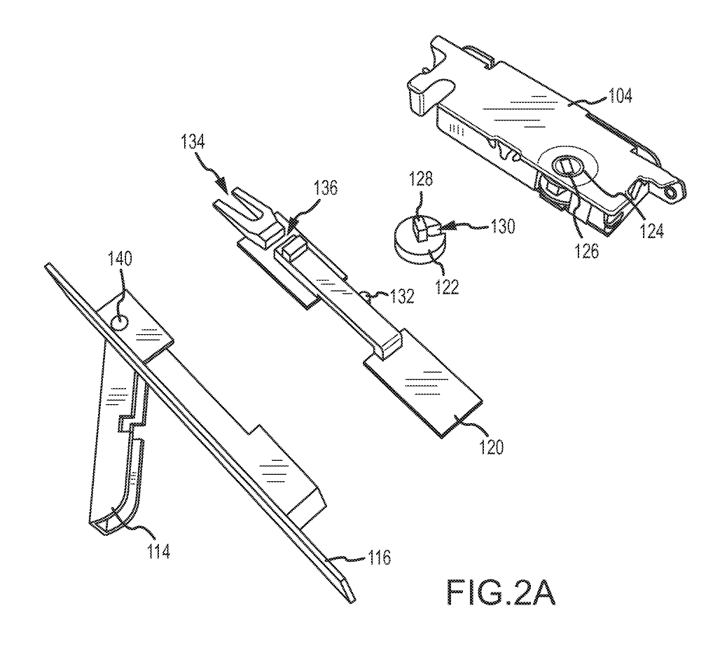

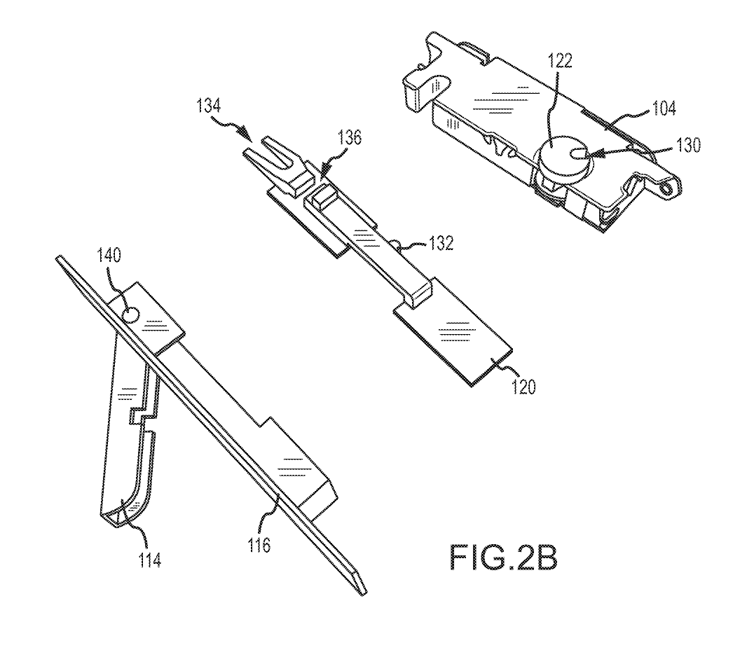

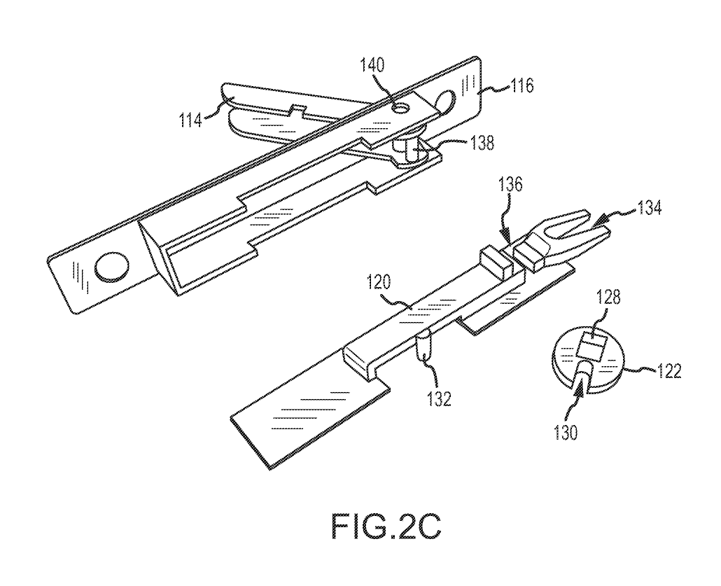

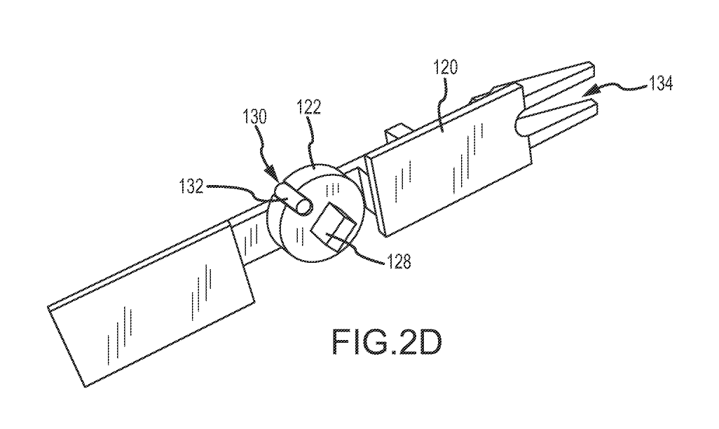

FIGS. 1A and 1B are perspective views of a lock assembly 100 in a locked position and an unlocked position, respectively. The lock assembly 100 may be installed in a stile 102 of a sliding door, for example, a sliding glass door or a pocket door. The lock assembly 100 includes a lock mechanism 104 having retractable locking member 106. In the depicted embodiment, the lock mechanism 104 may be the 537 series lock, sold by Amesbury Group, Inc.—Door Hardware Division, of Sioux Falls, S. Dak., or similar one- or two-point locks. The 537 series lock mechanism 104 includes a housing 108 and a locking member 106 pivotally connected thereto. An actuator 124 (FIG. 2A) is engaged with the locking member 106 and includes an actuator slot 126. Other lock mechanisms may also be utilized, such as, for example, the two-point assembly described in U.S. Pat. No. 7,418,845, the disclosure of which is hereby incorporated by reference herein in its entirety. The lock mechanism 104 is secured to a faceplate 110 located on a locking edge 112 of the door stile 102. The lock mechanism 104 is actuated by a handle 114 that is pivotably connected to an escutcheon plate 116.

When the handle 114 is in a first position (depicted in FIG. 1A), the locking member 106 is in an extended or locking position. A gap 118 is defined at least in part by the handle 114 and the escutcheon plate 116. The gap 118 is sized so as to allow access to the handle 114, thus allowing an operator to pivot the handle 114 from the first position to a second position (depicted in FIG. 1B). In the second position, the handle 114 extends beyond the escutcheon plate 116. In the depicted embodiment, the handle 114 extends substantially perpendicular to the escutcheon plate 116, providing a bearing element upon which an operator may push to slide the associated door within a door frame. Also, in the second position, the locking member 106 is retracted into the lock mechanism 104. The various lock assembly 100 components depicted may be secured to the stile 102 and to each other, as required, by screws, bolts, chemical adhesives or other means.

FIGS. 2A-2D are perspective views of components of the lock assembly 100 of FIGS. 1A and 1B, including the lock mechanism 104, the escutcheon plate 116 and handle 114 assembly, a slide 120, and a cam 122. The lock mechanism 104 includes the actuator 124 having a slot 126. The slot 126 engages with a tailpiece 128 that extends from the cam 122 (as depicted in FIG. 2B). The cam 122 also includes a slot 130 for receiving a cam-mating projection 132 that extends from the slide 120 (as depicted in FIG. 2D). In the depicted embodiment, the slide 120 includes a channel 134 for guiding the slide 120 as it moves from a first position to a second position. Additionally, the slide 120 includes a clutch 136 for engaging a dog or projection 138 on the handle 114. The escutcheon plate 116 and handle 114 are connected via an interface that in the depicted embodiment is a pin 140.

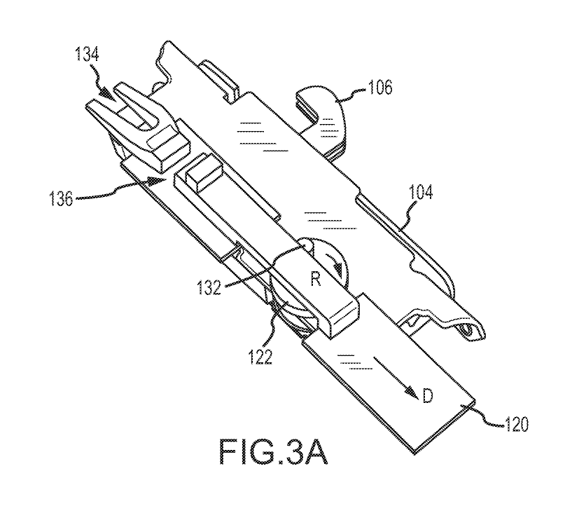

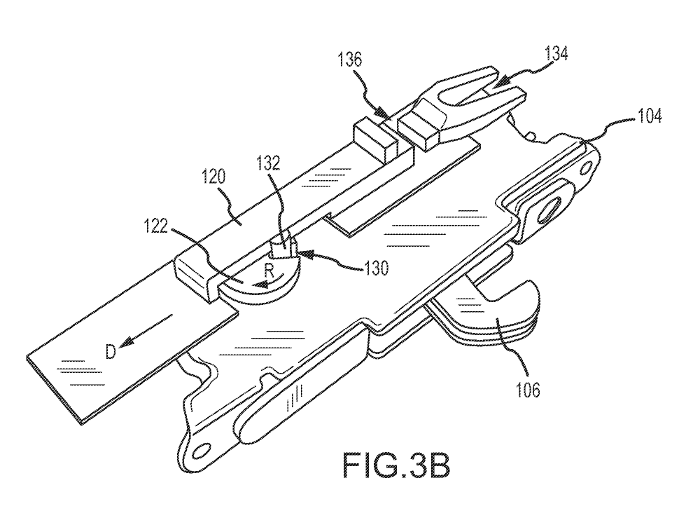

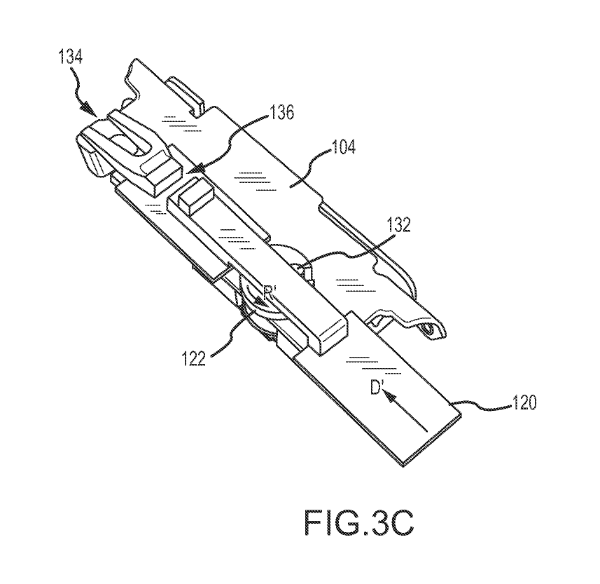

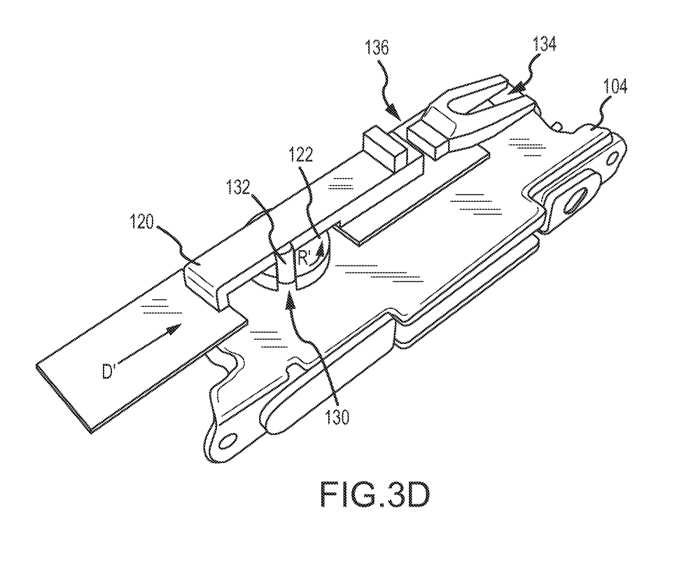

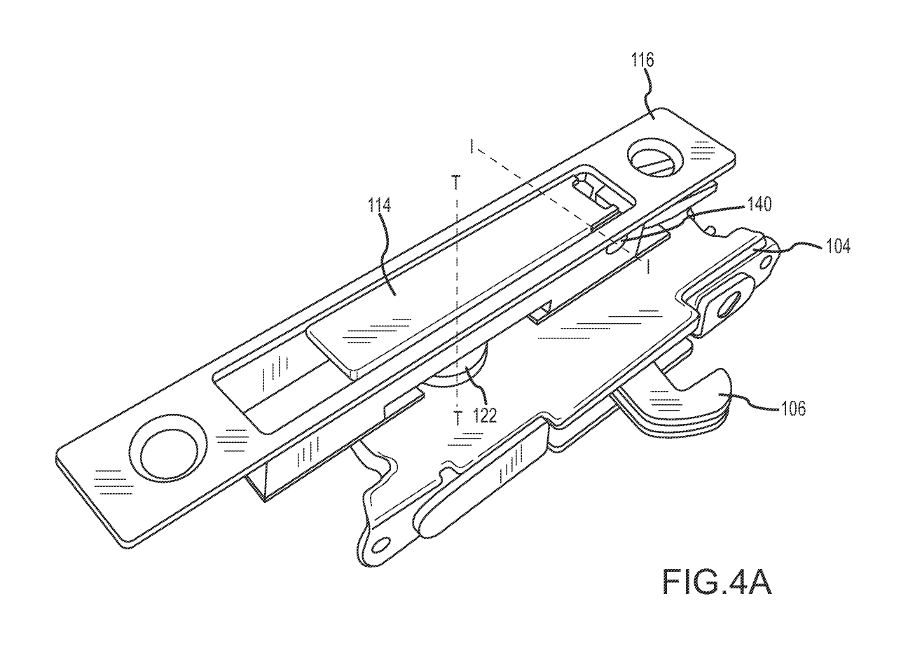

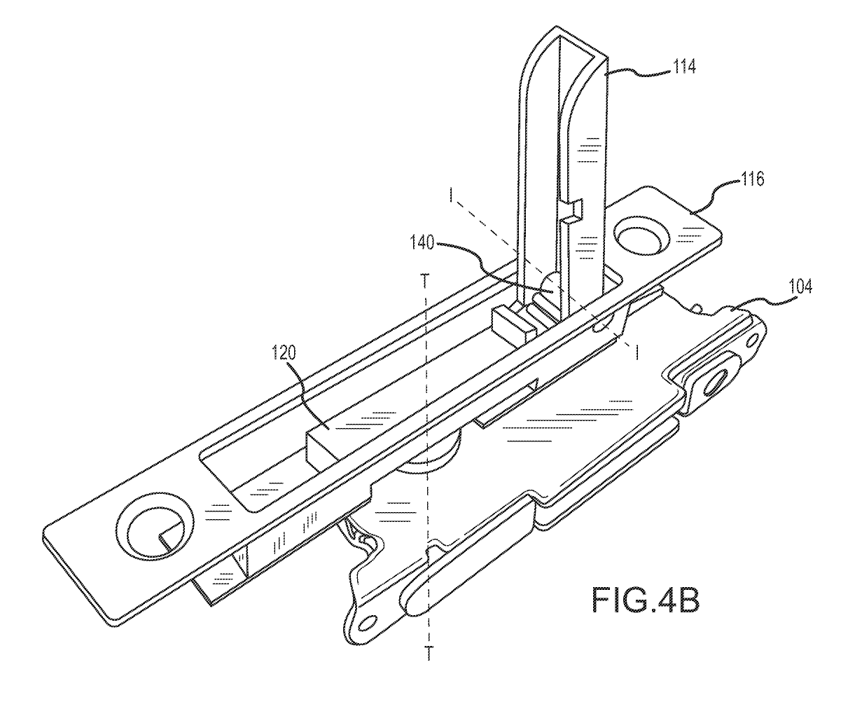

FIGS. 3A and 3B are perspective views of the lock assembly 100 of FIGS. 1A and 1B, partially assembled, in the locked position, where the locking member 106 is extended out of the lock mechanism 104. As assembled, the tailpiece 128 of the cam 122 is inserted into the slot 126 of the actuator 124. The cam-mating projection 132 extends into the slot 130 of the cam 122. The slide 120 may be manufactured of a low-friction material allowing it to slide easily against the housing 108 of the lock mechanism 104. To move the locking member 106 from the locked position to the unlocked position, the handle 114 must be moved from the first position depicted in FIG. 4A. As the handle 114 is lifted away from the escutcheon plate 116, the projection 138 engages the clutch 136 of the slide 120, forcing the slide 120 to move linearly in the direction D depicted in FIGS. 3A and 3B. The slide 120 is constrained to linear movement due to the presence of a screw, bolt, or other guide element within channel 134. As the slide 120 moves in direction D, the cam-mating projection 132 forces rotation R of the cam 122. In the depicted embodiment, the rotation R is clockwise. This rotation R, in turn, rotates the actuator 124 that retracts the locking member 106 into the lock mechanism 104. This places the lock assembly 100 in the unlocked position depicted in FIGS. 3C and 3D, with the handle 114 extending substantially orthogonally from the escutcheon plate 116. This position of the handle 114 is depicted in FIG. 4B. Once in the second position, force may be applied to the handle 114 to move the door. When desired, the handle 114 may be pushed back toward the escutcheon plate 116 so as to extend the locking member 106. As the handle 114 is pushed toward the escutcheon plate 116, the projection 138 engages the clutch 136 of the slide 120, forcing the slide 120 to move linearly in the direction D′ depicted in FIGS. 3C and 3D. As the slide 120 moves in the direction D′, the cam-mating projection 132 forces a counter-rotation R′ of the cam 122. The counter-rotation R′ is counterclockwise in this embodiment. This counter-rotation R′, in turn, rotates the actuator 124 that extends the locking member 106 from the lock mechanism 104. This places the lock assembly 100 back in the locked position depicted in FIGS. 3A and 3B, with the handle 114 proximate the escutcheon plate 116.

FIGS. 4A and 4B are perspective views of the lock assembly 100 of FIGS. 1A and 1B, partially assembled, in the locked position and the unlocked position, respectively. In the depicted embodiment, the escutcheon plate 106 defines a plane. In the locked position, in the depicted embodiment, a front face of the handle 114 is flush with the escutcheon plate 116. In other embodiments, the front face of the handle 114 may elevated or recessed, relative to the plane of the escutcheon plate 116. Flushed or recessed positions of the handle 114 allow the lock assembly 100 to be used in pocket door applications. Additionally, the low profile of the depicted lock assembly 100 prevents the handle 114 from being struck by persons or interfering with screen doors, blinds, or curtains. The interface 140 defines an interface axis I around which the handle 114 pivots. Additionally, the tailpiece 128 of the cam 122 defines a tailpiece axis T around which the cam 122 pivots. In the depicted embodiment, both the interface axis I and the tailpiece axis T are skew. The interface axis I is located in a position that is parallel to the escutcheon plate 116, but in other embodiments, may be located coplanar therewith. The tailpiece axis T is orthogonal to the plane defined by the escutcheon plate 116.

As clear from FIGS. 4A and 4B and the other figures, the handle 114 is pivotable between a first, stored position (FIG. 4A) and a second, extended position (FIG. 4B). Similarly, the slider 120 is movable between a first slider position (FIG. 3A) and a second slider position (FIG. 3C). Additionally, the cam 122 is pivotable between a first cam position (FIG. 3A) and a second cam position (FIG. 3C). When the handle 114, slider 120, and cam 122 are in each of their respective first positions, the locking element 106 is in the extended position, and when the handle 114, slider 120, and cam 122 are in each of their respective second positions, the locking element 106 is in the retracted position. The handle 114 may be any length desired. A longer handle increases the mechanical advantage of the handle to overcome the locking force of the locking mechanism. In certain embodiments, the handle may be of a length sufficient to require no more than five pounds actuation force, making the lock assembly 100 ADA compliant.

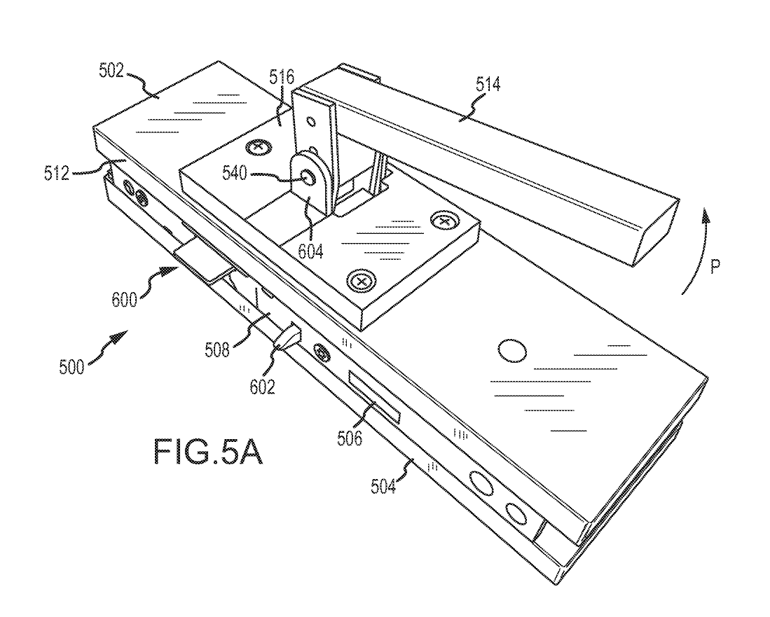

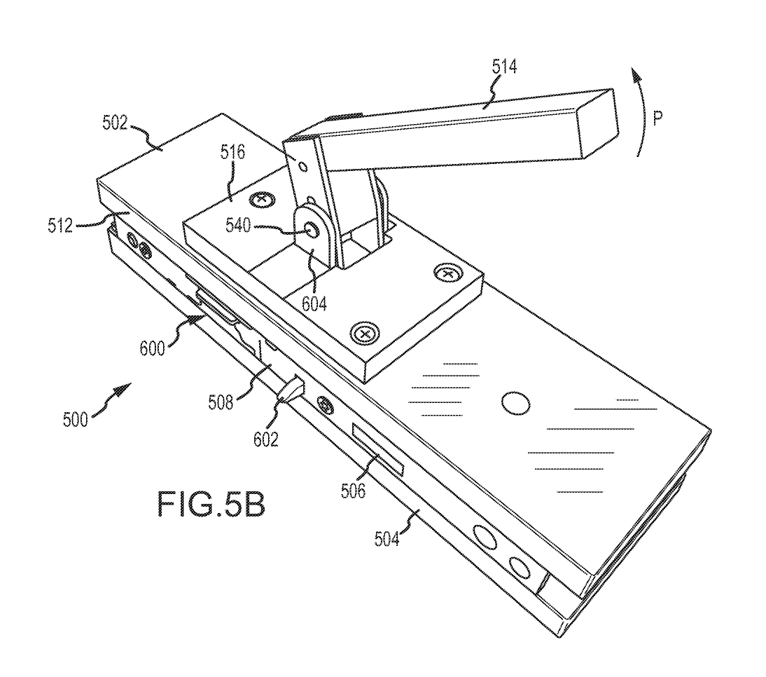

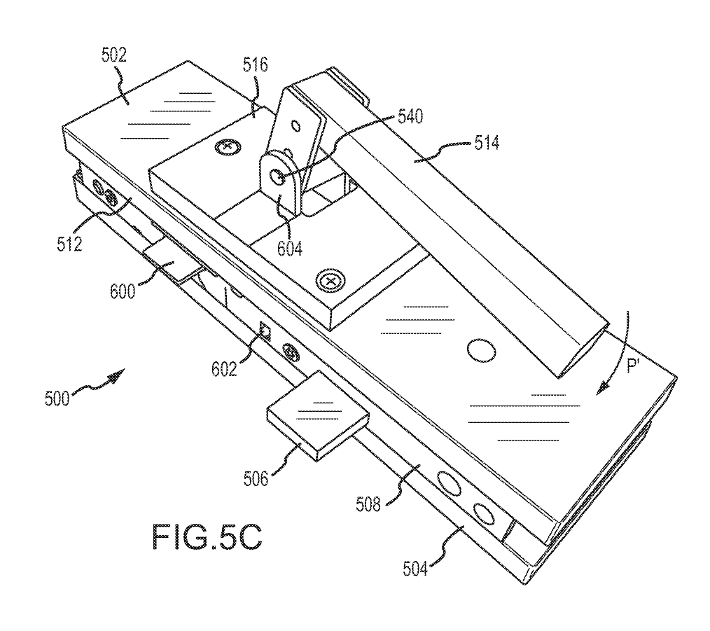

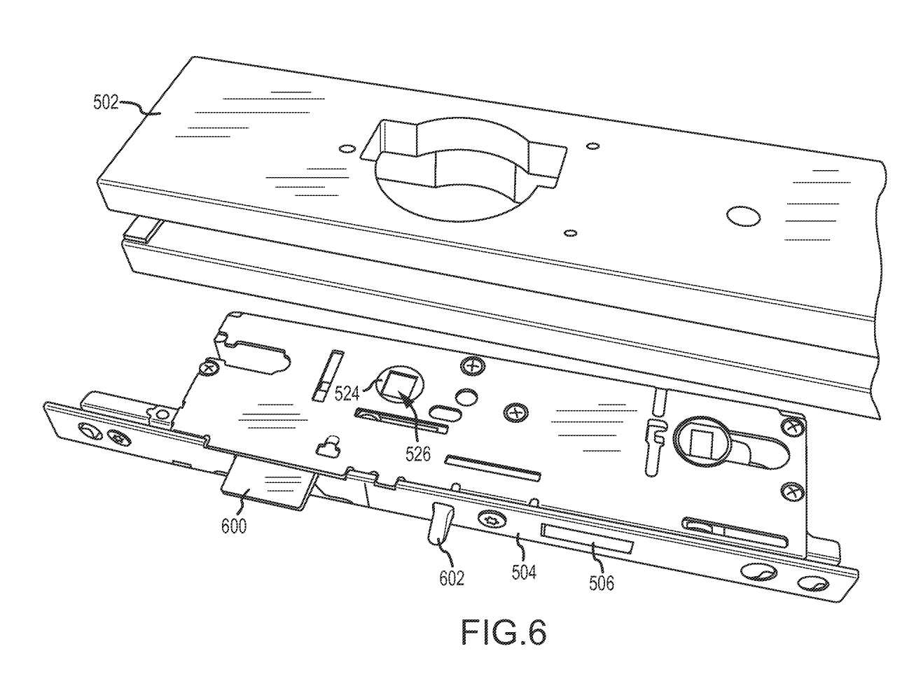

FIG. 5A-5C are perspective views of a lock assembly in latched, unlatched, and locked positions, respectively. The lock assembly 500 may be installed in a stile 502 of a hinged door. The lock assembly 500 includes a lock mechanism 504 having retractable locking member 506, a retractable latch 600, and an anti-slam mechanism 602. In the depicted embodiment, the lock mechanism 504 may be the P2000 series lock, sold by Amesbury Group, Inc.—Door Hardware Division, of Sioux Falls, S. Dak. The P2000 lock mechanism 504 includes a housing 508 and a locking member 506. Additionally, the lock mechanism may include a thumbturn that full secures the handle. In other words, in an embodiment that includes a thumbturn, the thumbturn prevents lifting of the handle, and retraction of the locking member, when the thumbturn is activated. An actuator 524 (FIG. 6) is engaged with the locking member 506 via an internal gear mechanism and includes an actuator slot 526. Other gearbox-type lock mechanisms may also be utilized. The latch 600, anti-slam element 602, and lock element 506 are located so as to project from a locking edge 512 of the door stile 502. The lock mechanism 504 is actuated by a handle 514 that is pivotably connected to an escutcheon plate 516. In the depicted embodiment, the handle 514 is connected at an interface pin 540 to a pair of projecting ears 604. Other connections are contemplated.

When the handle 514 is in a first position (depicted in FIG. 5A), the latch 600 is in an extended position. In the depicted embodiment, the first handle position is substantially parallel with the escutcheon plate 516. The handle 514 may be grasped or otherwise manipulated by an operator to pivot P the handle 514 from the first position to a second position (depicted in FIG. 5B). In the second position, the handle 514 extends away from the escutcheon plate 516. As the handle 514 is lifted, the latch retracts, allowing the operator to pull the associated door in a pivoting motion away from a door frame. The handle 514 may also be pivoted P′ from the first position to a third position (depicted in FIG. 5C). In the third position, the lock element 506 extends from the housing 508. It is known that embodiments of a locking mechanism having an anti-slam element 602, and the anti-slam element 602 must be depressed in order to extend the lock element. The various lock assembly 500 components depicted may be secured to the stile 502 and/or to each other, as required, by screws, bolts, chemical adhesives or other means.

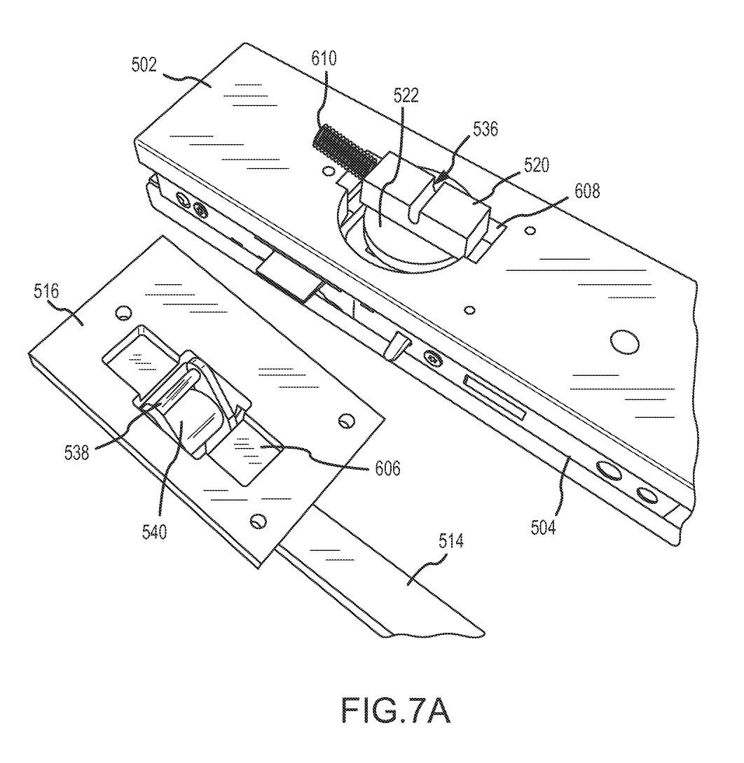

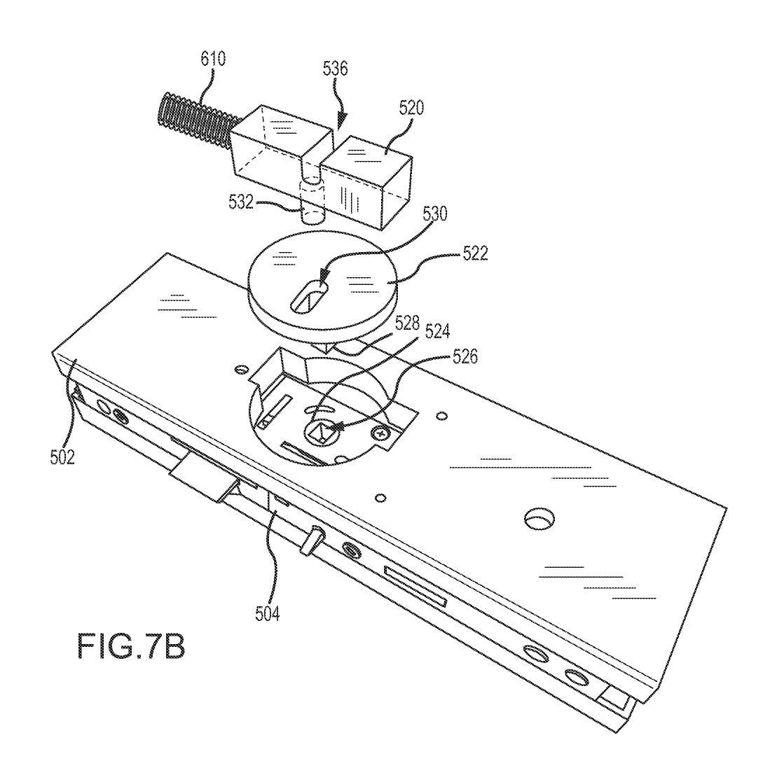

FIGS. 7A and 7B are perspective views of components of the lock assembly 500 of FIGS. 5A-5C, including the escutcheon plate 516 and handle 514 assembly, a slide 520, and a cam 522. The lock mechanism 504 includes the actuator 524 having the slot 526. The slot 526 engages with a tailpiece 528 (see FIG. 7B) that extends from the cam 522 (similar to the tailpiece 128 depicted in FIG. 2B) that is configured to mate with the slot 526. The cam 522 also includes a slot 530 for receiving a cam-mating projection 532 that extends from the slide 520. In the depicted embodiment, the slide 520 fits within recesses 606, 608, in the escutcheon plate 516 and stile 502, respectively. These recesses 606, 608 guide the slide 520 as it moves between the first position, the second position, and the third position. Additionally, the slide 520 includes a clutch 536 for engaging a dog or projection 538 on the handle 514. A spring 610 may be included for biasing the slider 120 into a desired position. The spring 120 also fits within the recesses 606, 608.

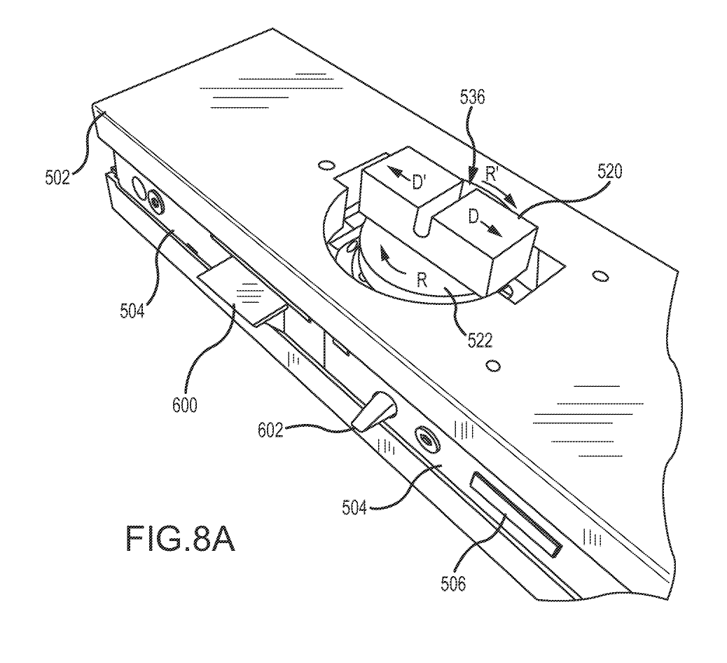

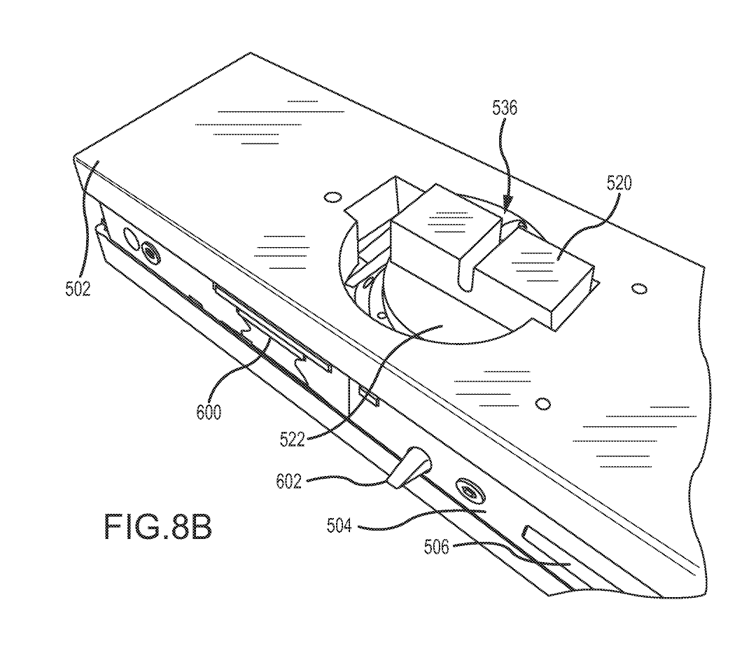

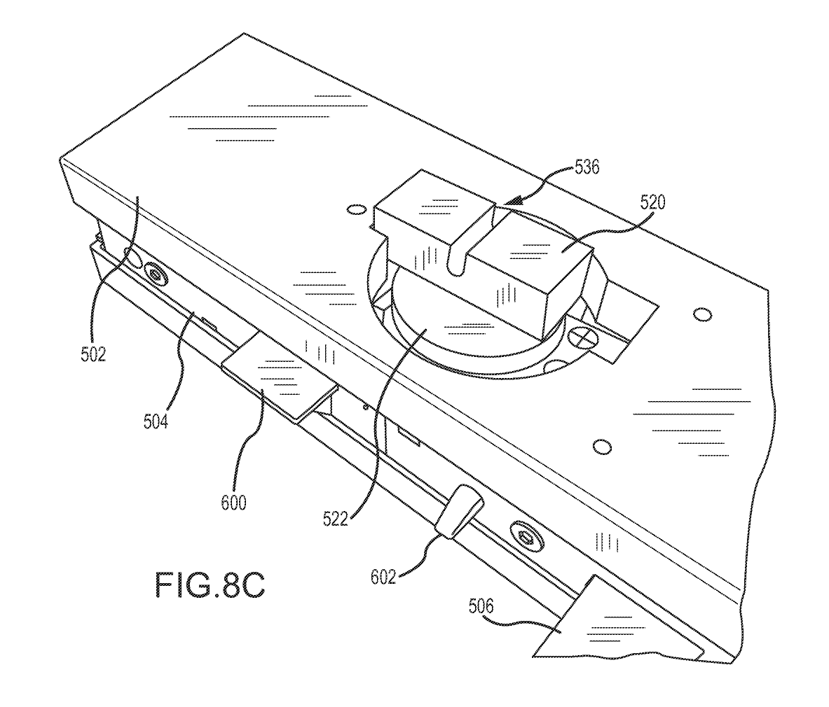

FIGS. 8A-8C are perspective views of the lock assembly 500 of FIGS. 5A-5C, partially assembled, in latched, unlatched, and locked positions, respectively. In FIGS. 8A-8C, the spring 610 has been removed for clarity. In the latched position depicted in FIG. 8A, the latch 600 extends out of the lock mechanism 504. As assembled, the tailpiece 528 of the cam 522 is inserted into the slot 526 of the actuator 524. The cam-mating projection 532 extends into the slot 530 of the cam 522. The slide 520 may be manufactured of a low-friction material allowing it to slide easily against the housing 508 of the lock mechanism 504. To move the latch 600 from the extended position to the retracted position, the handle 514 must be moved from the first position depicted in FIG. 5A. As the handle 514 is lifted away from the escutcheon plate 516, the projection 538 engages the clutch 536 of the slide 520, forcing the slide 520 to move linearly in the direction D. The slide 520 is constrained to linear movement due to its location within recesses 606, 608. As the slide 520 moves in direction D, the cam-mating projection 532 forces rotation R of the cam 522. The rotation R is, in the depicted embodiment, clockwise. This rotation R, in turn, rotates the actuator 524 that retracts the locking member 506 into the lock mechanism 504. At or proximate the end of the range of motion of the handle 514, the cam 522 and slider 520 are positioned as depicted in FIG. 8B. This places the lock assembly 500 in the unlatched position depicted in FIG. 8B, with the latch 600 retracted. A biasing element in the locking mechanism 504 or within the escutcheon plate 116 or at the handle 514 may bias the latch 600 back into the extended position of FIG. 8A. Once the latch 600 is retracted, force may be applied to the handle 514 to pivot the door.

When desired, the handle 514 may be pushed toward the escutcheon plate 516 so as to extend the locking member 506. In the depicted embodiment, the anti-slam element 602 was bypassed to allow extension of the lock element 506 without depression of the anti-slam element 602. As the handle 514 is pushed toward the escutcheon plate 516, the projection 538 engages the clutch 536 of the slide 520, forcing the slide 520 to move linearly in the direction D′ depicted in FIG. 8A. As the slide 520 moves in the direction D′, cam-mating projection 532 forces a counter-rotation R′ of the cam 522. The counter-rotation R′ is, in the depicted embodiment, counterclockwise. This counter-rotation R′, in turn, rotates the actuator 524 that extends the locking member 506 from the lock mechanism 504. This places the lock assembly 500 in the locked position depicted in FIG. 8C. Once in the locked position, a biasing element and/or lost-motion mechanism may allow the handle 514 to return to the first position depicted in FIG. 5A, without retracting the latch 600 or the lock element 506.

Returning to FIGS. 5A-5C, various components may be further characterized by their spatial relationships, as described and depicted with regard to FIGS. 4A and 4B. As in the first embodiment, the escutcheon plate 506 defines a plane. The handle 514 is elevated relative to the plane of the escutcheon plate 516. Flushed or recessed positions of the handle 514 are also contemplated. The interface 540 defines an interface axis I about which the handle 514 pivots. Additionally, the tailpiece 528 of the cam 522 defines a tailpiece axis T around which the cam 522 pivots. The interface axis I and the tailpiece axis T may be skew or may intersect, depending on the configuration. The interface axis I is located in a position that is parallel to the escutcheon plate 516, but in other embodiments, may be located coplanar therewith. The tailpiece axis T is orthogonal to the plane of the escutcheon plate 516.

As clear from FIGS. 5A-5C, 8A-8C, and the other figures, the handle 514 is pivotable between a first, neutral position (FIG. 5A), a second, raised position (FIG. 5B), and a third, depressed position (FIG. 5C). Similarly, the slider 520 is movable between a first slider position (FIG. 8A), a second slider position (FIG. 8B), and a third slider position (FIG. 8C). Additionally, the cam 522 is pivotable between a first cam position (FIG. 8A), a second cam position (FIG. 8B), and a third cam position (FIG. 8C). When the handle 514, slider 520, and cam 522 are in each of their respective first positions, the latch 600 is in the extended position; when the handle 514, slider 520, and cam 522 are in each of their respective second positions, the latch 600 is in the retracted position; and when the handle 514, slider 520, and cam 522 are in each of their respective third positions, the locking element 506 is in the extended position. Springs, lost motion mechanisms, and/or other elements may return the handle 514 to the first position once locking element 506 is extended. The handle 514 may be any length desired, as in the preceding embodiment. A longer handle increases the mechanical advantage of the handle to overcome the locking force of the locking mechanism. In certain embodiments, the handle may be of a length sufficient to require no more than five pounds actuation force, making the lock assembly 500 ADA compliant.

The materials utilized in the manufacture of the lock assembly may be those typically utilized for lock manufacture, e.g., zinc, steel, brass, stainless steel, etc. Material selection for most of the components may be based on the proposed use of the lock assembly, level of security desired, etc. Appropriate materials may be selected for a lock assembly used on patio or entry doors, or on doors that have particular security requirements, as well as on lock assemblies subject to certain environmental conditions (e.g., moisture, corrosive atmospheres, etc.). For particularly light-weight door panels (for example, cabinet door panels, lockers, or other types of panels), molded plastic, such as PVC, polyethylene, etc., may be utilized for the various components. Nylon, acetal, Teflon®, or combinations thereof may be utilized for the latch to reduce friction, although other low-friction materials are contemplated.

The terms first, second, third, retracted, extended, latched, unlatched, locked, unlocked, etc., as used herein, are relative terms used for convenience of the reader and to differentiate various elements of the lock assemblies from each other. In general, unless otherwise noted, the terms are not meant to define or otherwise restrict location of any particular element or the relationship between any particular elements. For example, the lock assembly 100 of FIGS. 1A-4B may be configured such that the handle 114 is in the extended position when the locking element 106 is in the extended, locking position. The lock systems described herein may be utilized in new doors or may be retrofitted into existing installations. As can be seen from the figures, the pivoting handles described herein differ significantly from conventional pivoting handles located on doors. Conventional pivoting handles pivot about an axis that is substantially orthogonal to a door panel, while the handles described herein pivot about an axis that is substantially parallel to a door panel.

While there have been described herein what are to be considered exemplary and preferred embodiments of the present technology, other modifications of the technology will become apparent to those skilled in the art from the teachings herein. The particular methods of manufacture and geometries disclosed herein are exemplary in nature and are not to be considered limiting. It is therefore desired to be secured in the appended claims all such modifications as fall within the spirit and scope of the technology. Accordingly, what is desired to be secured by Letters Patent is the technology as defined and differentiated in the following claims, and all equivalents.

What is claimed is:

1. A lock assembly comprising:
an escutcheon;
a handle pivotably connected to the escutcheon at an interface, the handle comprising a projection;
a slide comprising a clutch, wherein the projection engages the clutch;
a cam pivotably engaged with the slide, the cam comprising a tailpiece adapted for engagement with a locking mechanism.

2. The lock assembly of claim 1, wherein the interface comprises an interface axis and the tailpiece comprises a tailpiece axis, wherein the cam pivots about the tailpiece axis, and wherein the interface axis and the tailpiece axis are skew.

3. The lock assembly of claim 2, wherein the escutcheon defines an escutcheon plane, and wherein the interface axis is at least one of parallel to the escutcheon plane and located within the escutcheon plane.

4. The lock assembly of claim 3, wherein the tailpiece axis is orthogonal to the escutcheon plane.

5. The lock assembly of claim 1, wherein the handle is pivotable between a first handle position and a second handle position, wherein the slider is movable between a first slider position and a second slider position, wherein the cam is pivotable between a first cam position and a second cam position, and wherein when the handle is in the first handle position, the slider is in the first slider position, and the cam is in the first cam position.

6. The lock assembly of claim 5, wherein the handle is pivotable to a third handle position, wherein the slider is movable to a third slider position, wherein the cam is pivotable to a third cam handle position, and wherein when the handle is in the third handle position, the slider is in the third slider position, and the cam is in the third cam position.

7. The lock assembly of clam 6, further comprising a spring for biasing the slider from the third slider position to the first slider position.

8. The lock assembly of claim 1, wherein the slider comprises a cam-mating projection and the cam defines a slot for receiving the cam-mating projection.

9. The lock assembly of claim 1, wherein when in a first handle position, a front surface of the handle is flush with the escutcheon.

10. The lock assembly of claim 1, further comprising the locking mechanism.

11. A door lock comprising the lock assembly of claim 1.

12. A lock assembly comprising:
a locking mechanism comprising:
a housing;
an actuator rotatably located within the housing; and
a locking member configured to extend from the housing upon a rotation of the actuator;
a cam engaged with the actuator, such that a rotation of the cam rotates the actuator;
a slider comprising a cam-mating projection configured to mate with the cam, such that a linear movement of the slider rotates the cam, wherein the slider comprises a clutch;
a handle comprising a projection, wherein the handle engages the clutch; and
an escutcheon, wherein the handle is pivotably mounted to the escutcheon.

13. The lock assembly of claim 12, wherein the cam comprises a tailpiece projecting therefrom, wherein the tailpiece engages the actuator.

14. The lock assembly of claim 13, wherein the escutcheon defines and escutcheon plane, and wherein the tailpiece comprises an axis orthogonal to the escutcheon plane.

15. The lock assembly of claim 14, wherein the handle and the escutcheon are pivotably connected at an interface defining an interface axis, wherein the interface axis is parallel to the escutcheon plane.

16. The lock assembly of claim 15, wherein the interface axis is at least one of parallel to the escutcheon place and located within the escutcheon plane.

17. The locking assembly of claim 13, further comprising a spring for biasing the slider into a first position.

18. The locking assembly of claim 13, wherein the slider defines a channel for accommodating passage of a screw, wherein the screw is adapted to secure the escutcheon to a door.

19. The locking assembly of claim 18, wherein the screw constrains the slider to a linear movement.
